(19) United States
(12) Patent Application Publication
(10) Pub. No.: US 2014/0218479 A1
(43) Pub. Date: Aug. 7, 2014

(54) 3D ENDOSCOPE DEVICE

(71) Applicant: OLYMPUS CORPORATION, Tokyo (JP)

(72) Inventor: Hisashi Nishimura, Tokyo (JP)

(73) Assignee: OLYMPUS CORPORATION, Tokyo (JP)

(21) Appl. No.: 14/248,931

(22) Filed: Apr. 9, 2014

Related U.S. Application Data
(63) Continuation of application No. PCT/JP2012/076461, filed on Oct. 12, 2012.

(30) Foreign Application Priority Data
Oct. 14, 2011 (JP) 2011-226756

(51) Int. Cl. H04N 13/02

(52) U.S. Cl. CPC H04N 13/0207; H04N 2005/2255
USPC 348/46

(57) ABSTRACT

A 3D endoscope device includes an endoscopic scope, an image processor, and an image display device. A line which connects the center of a first image and the center of a second image formed on the light receiving surface of the CMOS sensor is orthogonal to a parallax direction. On the light receiving surface of the CMOS sensor, a first region where the center of the first image and the second image are formed is divided into a plurality of first divided regions, and a second region is divided into a plurality of second divided regions. When reading data constituting video signals from the first region and the second region, the CMOS sensor reads data by alternately scanning the first divided region at a position corresponding to the image for left-eye and the second divided region at a position corresponding to the image for right-eye.

This application is a continuation application based on PCT/JP2012/076461, filed on Oct. 12, 2012, claiming priority based on Japanese Patent Application No. 2011-226756, filed in Japan on Oct. 14, 2011. The contents of both the Japanese Patent Application and the PCT Application are incorporated herein by reference.

### TECHNICAL FIELD

The present invention relates to a 3D endoscope device which forms images for left-eye and right-eye on a single MOS sensor.

### BACKGROUND ART

A 3D endoscope device which forms images for left-eye and right-eye with parallax on a single MOS sensor to realize a stereoscopic view is known. From the relationship with a mounting space of the endoscopic scope, a system in which images for left-eye and right-eye are formed on a single imaging element with a light receiving surface having a substantially square shape is preferably used compared to a system which uses a plurality of imaging elements.

When forming an image for left-eye and an image for right-eye on a single imaging element, in general, the image for left-eye (hereinafter referred to as “ILE”) and the image for right-eye (hereinafter referred to as “IRE”) are formed in left and right divided regions of the light receiving surface of the imaging element. However, when obtaining a high-definition image, it is necessary to generate a 16:9 horizontally long image. Accordingly, in the system in which the images are formed in the left and right divided regions of the light receiving surface of the imaging element having a substantially square shape, the image should be enlarged later in the horizontal direction with a large magnification, causing deterioration of image quality. As a means for solving this problem, Republished Japanese Translation No. 2004/106857 of the PCT International Publication for Patent Applications suggests that, as shown in FIG. 7, an ILE and an IRE are formed in upper and lower divided regions S11 and S12 of a light receiving surface of an imaging element.

### SUMMARY OF THE INVENTION

The present invention has been accomplished in order to solve the above-described problem, and in a first aspect of the present invention, a 3D endoscope device which acquires an image for left-eye and an image for right-eye with parallax, the 3D endoscope device includes an endoscopic scope which has two optical systems that form light corresponding to the image for left-eye and the image for right-eye, and a MOS sensor on which a first light and a second light obtained through the two optical systems are formed separately on a single light receiving surface and which generates a video signal based on formed a first image and a second image, an image processor which performs image processing on the video signal, and an image display device which displays an image including the image for left-eye and the image for right-eye based on the video signal processed by the image processor, in which a line which connects a center of the first image and a center of the second image formed on the light receiving surface of the MOS sensor is orthogonal to a parallax direction, on the light receiving surface of the MOS sensor, a first region where the first image is formed is divided into a plurality of first divided regions, and a second region where the second image is formed is divided into a plurality of second divided regions, and when reading data constituting the video signal from the first region and the second region, the MOS sensor reads the data by alternately scanning the first divided region at a position corresponding to the image for left-eye and the second divided region at a position corresponding to the image for right-eye.

According to a second aspect of the present invention, in the 3D endoscope device according to the first aspect of the present invention, the MOS sensor may read data by scanning the plurality of first divided regions and the plurality of second divided regions by raster scan, and a direction of the raster scan may be orthogonal to the parallax direction.

According to a third aspect of the present invention, in the 3D endoscope device according to the first aspect of the present invention, the image processor may include an image processing unit which performs the image processing, a separation unit which separates the video signal into a video signal for left-eye corresponding to the image for left-eye and a video signal for right-eye corresponding to the image for right-eye, and an adjustment unit which rearranges an order of data constituting each of the video signal for left-eye and the video signal for right-eye so as to be the same as an order of data when data is read by scanning the plurality of first divided regions and the plurality of second divided regions by the raster scan in a same direction as the parallax direction.

According to a fourth aspect of the present invention, in the 3D endoscope device according to the third aspect of the present invention, the image processor may include a control unit which instructs a calibration operation before a normal operation or during the normal operation, a displacement detection unit which detects an amount of displacement of the image for left-eye and the image for right-eye during the calibration operation, a correction amount calculation unit which calculates correction amounts of the image for left-eye and the image for right-eye during the calibration operation, and a correction unit which performs correction on the video signal according to the correction amounts of the image for left-eye and the image for right-eye.

According to a fifth aspect of the present invention, in the 3D endoscope device according to the fourth aspect of the present invention, the displacement detection unit may detect the amount of displacement for at least one factor of brightness, white balance, size, rotation, and parallel movement, and the correction amount calculation unit may calculate a correction amount corresponding to the amount of displacement for each factor.

### BRIEF DESCRIPTION OF DRAWINGS

FIG. 1 is a configuration diagram showing the schematic configuration of a 3D endoscope device according to an embodiment of the present invention.

FIG. 2 is a reference diagram showing a light receiving surface of a CMOS sensor in a 3D endoscope device according to an embodiment of the present invention.

FIG. 3 is a reference diagram showing a form in which a CMOS sensor in a 3D endoscope device according to an embodiment of the present invention reads data constituting a video signal from respective pixels by scanning a light receiving surface.

FIG. 4 is a block diagram showing the configuration of an image processor in a 3D endoscope device according to an embodiment of the present invention.

FIG. 5 is a reference diagram showing a form of processing which is performed by a video signal separation unit and a video signal adjustment unit of an image processor in a 3D endoscope device according to an embodiment of the present invention.

FIG. 6 is a reference diagram showing a form in which a CMOS sensor in a 3D endoscope device according to an embodiment of the present invention reads data constituting a video signal from respective pixels by scanning a light receiving surface.

FIG. 7 is a reference diagram showing a form in which left and right images are formed on an imaging element.

FIG. 8 is a reference diagram illustrating a difference in accumulation time by the characteristic of a rolling shutter of a MOS sensor.

### DESCRIPTION OF EMBODIMENTS

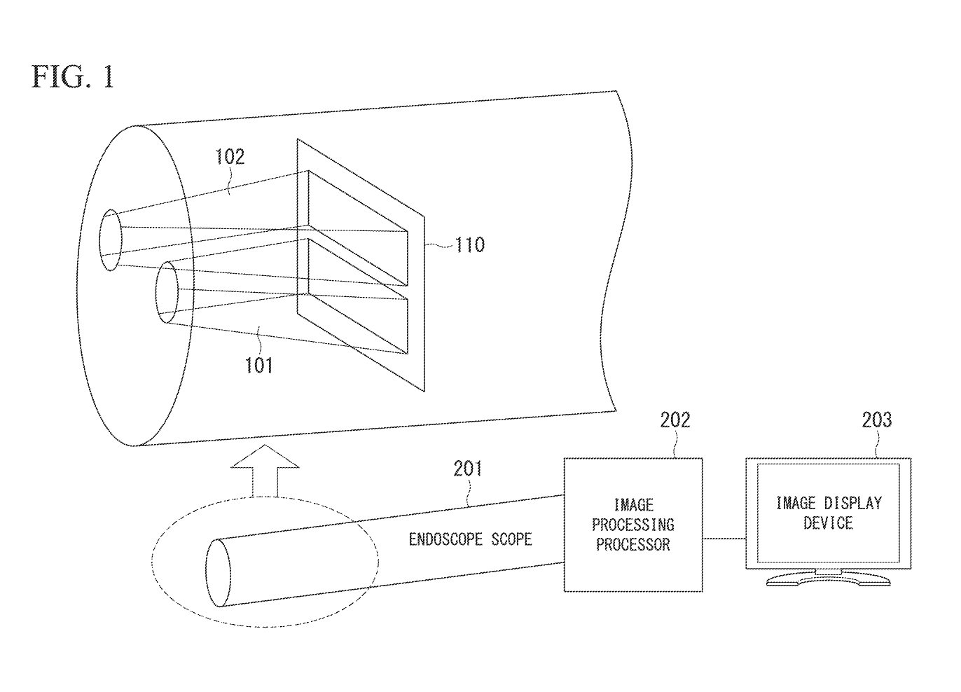

Hereinafter, an embodiment of the present invention will be described referring to the drawings. FIG. 1 shows the schematic configuration of a 3D endoscope device according to an embodiment of the present invention. The outline of the 3D endoscope device will be described with reference to FIG. 1.

The 3D endoscope device includes an endoscopic scope 201 having a left-eye optical system 101, a right-eye optical system 102, and a CMOS sensor 110 (MOS sensor), an image processor 202, and an image display device 203 as a monitor. The left-eye optical system 101, the right-eye optical system 102, and the CMOS sensor 110 are arranged at the distal end of the endoscopic scope 201.

The left-eye optical system 101 and the right-eye optical system 102 are two optical systems which form light corresponding to an ILE and an IRE. The left-eye optical system 101 and the right-eye optical system 102 have an angle of view suitable for a high-definition image, for example, with an aspect ratio of 16:9. The left-eye optical system 101 and the right-eye optical system 102 are arranged in the form of providing parallax appropriate for three-dimensional display between the ILE and the IRE. Two systems of light (first light and second light) having passed through the left-eye optical system 101 and the right-eye optical system 102 are separated vertically on a light receiving surface of the CMOS sensor 110 and formed as an ILE and an IRE.

The CMOS sensor 110 generates a video signal based on the ILE (first image) and the IRE (second image) formed on the light receiving surface. The image processor 202 performs image processing on the video signal output from the CMOS sensor 110. The image display device 203 displays an image including the ILE and the IRE on the basis of the video signal processed by the image processor 202.

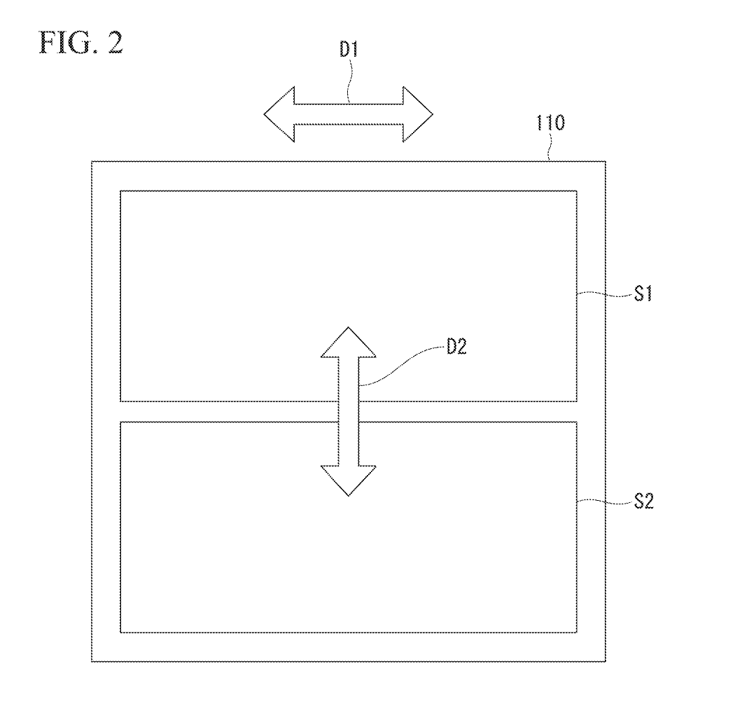

The vertical and horizontal relationship expressed herein will be explained with reference to FIG. 2. FIG. 2 shows the light receiving surface of the CMOS sensor 110. On the light receiving surface of the CMOS sensor 110, a plurality of pixels which generate data based on the formed light are arranged in a matrix. The light receiving surface of the CMOS sensor 110 has a region S1 (first region) where light having passed through the left-eye optical system 101 is formed as an ILE, and a region S2 (second region) where light having passed through the right-eye optical system 102 is formed as an IRE. A direction (parallax direction) in which parallax is provided between the ILE and the IRE is a horizontal direction (the direction of arrow D1 of FIG. 2), and the direction (the arrangement direction of the region S1 and the region S2) of a line which connects the centers of the ILE and the IRE formed to be separated in two on the light receiving surface of the CMOS sensor 110 is a vertical direction (the direction of arrow D2 of FIG. 2). The two directions are orthogonal to each other.

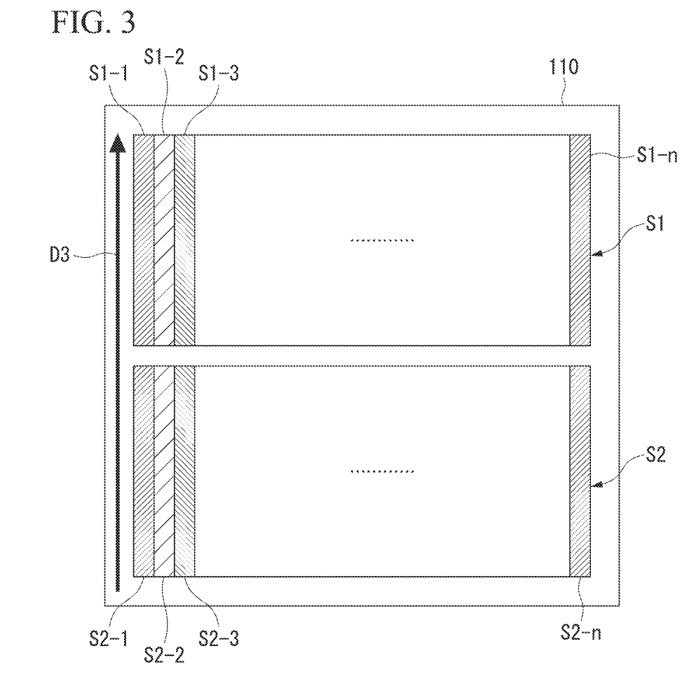

FIG. 3 shows a form in which the CMOS sensor 110 reads data constituting a video signal from the respective pixels arranged in a matrix on the light receiving surface by scanning the light receiving surface by raster scan. The direction (the direction of arrow D3 of FIG. 3) in which the CMOS sensor 110 scans the light receiving surface is orthogonal to the parallax direction. The region S1 and the region S2 are divided into a plurality of divided regions. The region S1 has a divided region S1-1, a divided region S1-2, a divided region S1-3, . . . , and a divided region S1-n (first divided regions) which are divided in units of columns of pixels arranged in a matrix. The region S2 has a divided region S2-1, a divided region S2-2, a divided region S2-3, . . . , and a divided region S2-n (second divided regions) which are divided in units of columns of pixels arranged in a matrix. Each divided region in the region S1 is associated with each divided region in the same column of the region S2. For example, the divided region S1-1 corresponds to the divided region S2-1, and the divided region S1-n corresponds to the divided region S2-n.

The CMOS sensor 110 scans the light receiving surface in the direction of arrow D3 and reads data constituting the video signal from the respective pixels of each divided region. Accordingly, the respective divided regions in the region Si and the respective divided regions in the region S2 are alternately scanned. Specifically, the respective divided regions are scanned in an order (sequence) of the divided region S2-1, the divided region S1-1, the divided region S2-2, the divided region S1-2, the divided region S2-3, the divided region S1-3, . . . , the divided region S2-n, and the divided region S1-n. In this way, the region S1 and the region S2 are alternately scanned in the same direction with the divided regions divided in units of columns as a scan unit.

Accordingly, the difference in the time (accumulation start time or end time) at which optical information is accumulated as electrical information at the corresponding positions of an ILE and an IRE (the positions in an ILE and an IRE which are identical on the respective images) becomes a very small amount of time which is half the scan time per line. For example, the difference between the time at which optical information is accumulated as electrical information in the uppermost pixel of the divided region S1-1 and the time at which optical information is accumulated as electrical information in the uppermost pixel of the corresponding divided region S2-1 is half the scan time per line (the total scan time of the divided region S1-1 and the divided region S2-1). The CMOS sensor 110 outputs a video signal, in which data of an ILE and data of an IRE are alternately mixed, to the image processor 202.

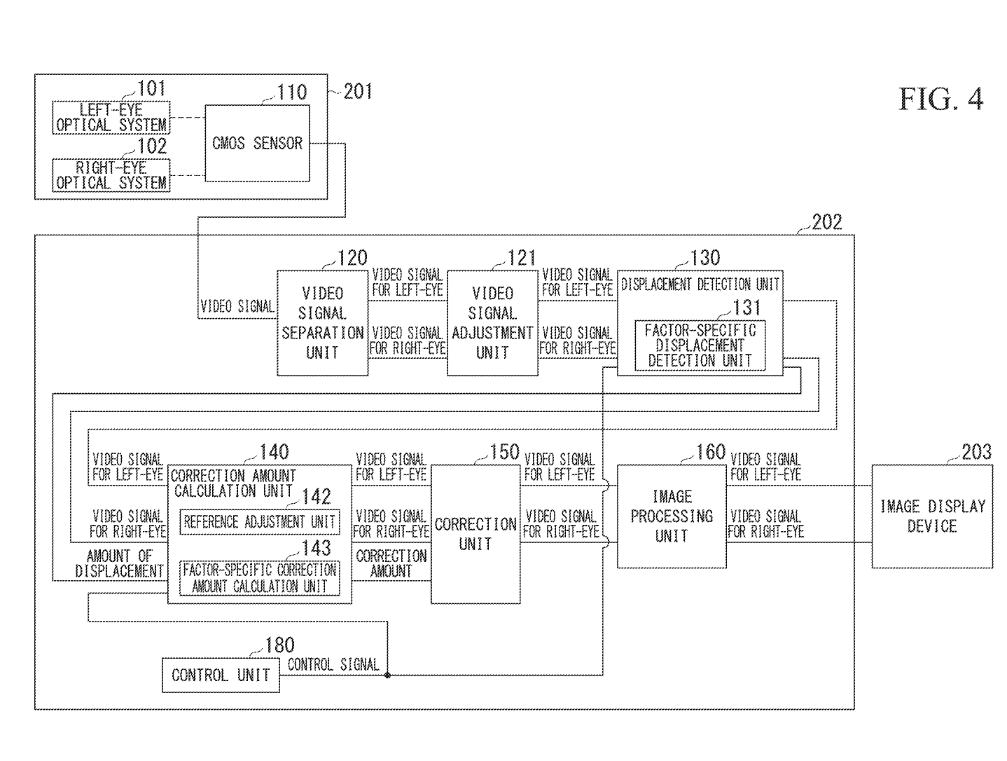

FIG. 4 shows the detailed configuration of the image processor 202. The image processor 202 has a video signal separation unit 120, a video signal adjustment unit 121, a displacement detection unit 130, a correction amount calculation unit 140, a correction unit 150, an image processing unit 160, and a control unit 180.

The video signal separation unit 120 separates the video signal, in which data of the ILE and data of the IRE are alternately mixed, into a video signal for left-eye constituted by data of the ILE and a video signal for right-eye constituted by data of the IRE. Accordingly, subsequent processing can be performed in a unit of each of the images for left-eye and right-eye.

The video signal adjustment unit 121 adjusts the order of data constituting each of the video signal for left-eye and the video signal for right-eye output from the video signal separation unit 120. The light receiving surface of the CMOS sensor 110 is scanned in the vertical direction, whereby the sequence of data of the respective pixels is in a special state. For this reason, the video signal adjustment unit 121 adjusts (rearranges) the order of data constituting the video signal for left-eye so as to be the same as the order of data of the respective pixels when the region S1 is scanned in the same direction as the parallax direction by raster scan. The video signal adjustment unit 121 adjusts (rearranges) the order of data constituting the video signal for right-eye so as to be the same as the order of data of the respective pixels when the region S2 is scanned in the same direction as the parallax direction by raster scan. Accordingly, the order of data constituting each of the video signal for left-eye and the video signal for right-eye is the same as the order of data to be finally input to the image display device 203.

While a memory is generally used for data rearrangement, if a video signal for left-eye and a video signal for right-eye are separately written in a left-eye memory and a right-eye memory, and data is managed in units of left and right memories, it is not necessary to separately prepare a separation process.

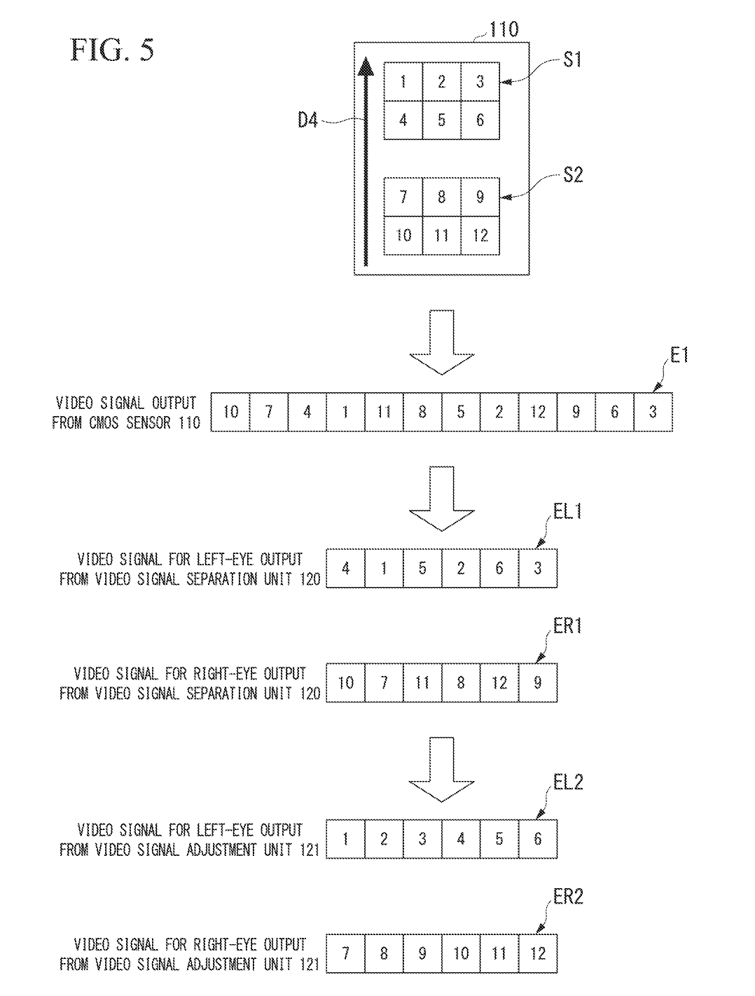

FIG. 5 shows a form of processing which is performed by the video signal separation unit 120 and the video signal adjustment unit 121. For simplification of description, on the light receiving surface of the CMOS sensor 110, the pixels of the region S1 where the ILE is formed and the pixels of the region S2 where the IRE is formed are arranged in two rows and three columns. In order to distinguish between 12 pixels shown in FIG. 5, the numbers of 1 to 12 are attached to the respective pixels.

Since the light receiving surface of the CMOS sensor 110 is scanned in the vertical direction (the direction of arrow D4 of FIG. 5), data of respective pixels in a video signal E1 output from the CMOS sensor 110 are arranged in an order shown in FIG. 5. The video signal separation unit 120 separates the video signal E1 into a video signal for left-eye EL1 and a video signal for right-eye ER1. The video signal adjustment unit 121 adjusts the order of data of the respective pixels constituting the video signal for left-eye EL1 and generates a video signal for left-eye EL2. The video signal adjustment unit 121 adjusts the order of data of the respective pixels constituting the video signal for right-eye ER1 and generates a video signal for right-eye ER2. The order of data of the respective pixels in the video signal for left-eye EL2 is the same as the order of data of the respective pixels when the region S1 is scanned in the same direction as the parallax direction by raster scan. The order of data of the respective pixels in the video signal for right-eye ER2 is the same as the order of data of the respective pixels when the region S2 is scanned in the same direction as the parallax direction by raster scan.

The displacement detection unit 130 and the connection amount calculation unit 140 operate on the basis of a control signal output from the control unit 180. The control signal output from the control unit 180 is a signal which instructs an operation mode. The 3D endoscope device of this embodiment has a normal mode and a calibration mode as the operation mode. The calibration mode is instructed before the normal operation or during the normal operation. If the control signal instructs the calibration mode, the displacement detection unit 130 and the correction amount calculation unit 140 detect displacement between the ILE and the IRE on the basis of the video signal for left-eye and the video signal for right-eye, and calculate a correction amount. The calculated correction amount is saved at the end of calibration and used in the normal mode. In the normal mode, the displacement detection unit 130 stops operating, or cancels the calculated amount of displacement or does not update the amount of displacement even if operates. In the normal mode, the correction amount calculation unit 140 stops operating, except for below-described strain correction, or cancels the calculated correction amount or does not update the correction amount even if operates. Other than in the displacement detection unit 130 and the correction amount calculation unit 140, a single operation is performed without reference to the control signal.

The displacement detection unit 130 has five factor-specific displacement detection units 131 which individually detect displacement for respective factors of brightness, white balance, size, rotation, and parallel movement. In FIG. 4, only one factor-specific displacement detection unit 131 is shown, and other four factor-specific displacement detection units 131 are omitted. Hereinafter, the operation of the factor-specific displacement detection unit 131 in the calibration mode will be described in detail.

In order to detect displacement, in the calibration mode, the 3D endoscope device images a calibration tool on which a chart image is drawn. Although various images are considered as the chart image drawn on the calibration tool, in this embodiment, an example where a square which is blackened in the central portion of a white background is drawn will be described.

The factor-specific displacement detection unit 131 for brightness detects the amount of displacement of brightness of the IRE with respect to the ILE from the luminance average of the ILE and the IRE or the like. A range in which the average is obtained may be the entire image or just a predefined range. Although the amount of displacement of brightness is the ratio of luminance, a difference in luminance may be used.

In regard to the amount of displacement of white balance, the amount of displacement of the ILE with respect to a balanced state and the amount of displacement of the IRE with respect to a balanced state are detected by the factor-specific displacement detection unit 131 for white balance.

In regard to the amount of displacement of size, rotation, and parallel movement, after predetermined strain correction is performed on the video signal for left-eye and the video signal for right-eye in advance, the amount of displacement is detected. In order to reproduce an image which is preferred for the lens characteristic of the endoscopic scope or an operator, predetermined strain occurs in an endoscope image. It is possible to accurately detect the amount of displacement of size, rotation, and parallel movement by removing the strain.

The factor-specific displacement detection units 131 for size, rotation, and parallel movement analyze the ILE and the IRE to detect the amount of displacement. In a state where strain is removed and the square can be recognized as a square, the boundary position of black and white is detected, whereby the coordinates of the four vertexes of the square are easily obtained.

The factor-specific displacement detection unit 131 for size calculates the ratio of the distances between the vertexes of the respective images, and for example, detects the ratio of the distances between the vertexes of the IRE with respect to the ILE as the amount of displacement. In this embodiment, the distance between the vertexes of each image corresponds to the size of each image. Since the distance between the chart image drawn on the calibration tool and the lens is constant, and a predetermined amount of intrinsically set parallax does not affect the size, it should suffice that simply the ratio of size is obtained. For example, the distance between two arbitrary vertexes among the four vertexes detected from the ILE and the distance between two vertexes corresponding to the two vertexes in the ILE with the distance calculated, among the four vertexes detected from the IRE are calculated, and the ratio of the distances is calculated.

The factor-specific displacement detection unit 131 for rotation calculates an inclination angle obtained from the vertexes of the respective images, and for example, detects the difference in the inclination angle of the IRE with respect to the ILE as the amount of displacement. Since the distance between the chart image drawn on the calibration tool and the lens is constant, and a predetermined amount of intrinsically set parallax does not affect the inclination angle, it should suffice that the difference between simply the inclination angles is obtained. For example, the inclination angle of a line passing through two arbitrary vertexes among the four vertexes detected from the ILE and the inclination angle of a line passing through two vertexes corresponding to the two vertexes in the ILE, through which the line with the inclination angle calculated passes, among the four vertexes detected from the IRE are calculated, and the difference between the inclination angles is calculated.

The factor-specific displacement detection unit 131 for parallel movement calculates the difference between the center positions of the respective images, and for example, detects the difference in the position of the IRE with respect to the ILE as the amount of displacement. Instead of simply using the difference in the position as the amount of displacement, the amount of displacement is obtained taking into consideration a predetermined amount of intrinsically set parallax.

In regard to displacement other than white balance, although a case where the amount of displacement is detected with reference to the ILE has been described, the amount of displacement may be detected with reference to the IRE. The above-described detection method for the amount of displacement is just an example, and various detection methods may be considered.

The correction amount calculation unit 140 has a reference adjustment unit 142 and five factor-specific correction amount calculation units 143 which calculate a correction amount of displacement of each of brightness, white balance, size, rotation, and parallel movement. In FIG. 4, only one factor-specific correction amount calculation unit 143 is shown, and other four factor-specific correction amount calculation units 143 are omitted. Hereinafter, the operation of the factor-specific correction amount calculation unit 143 in the calibration mode will be described in detail.

Although there is an absolute reference for white balance correction, there is no absolute reference for brightness, size, rotation, and parallel movement. Furthermore, although the ILE and the IRE are compared to each other to understand the amount of displacement between both images, it is difficult to understand whether either the ILE or the IRE is displaced or both the ILE and the IRE are displaced.

Accordingly, in order to allow a user to select an image as a reference of brightness, size, inclination angle, and position from the ILE and the IRE, the reference adjustment unit 142 is provided. The reference adjustment unit 142 selects an image instructed by the user as a reference of brightness, size, inclination angle, and position from the ILE and the IRE.

The factor-specific correction amount calculation unit 143 for white balance calculates the correction amounts of the ILE and the IRE on the basis of an absolute amount of displacement of white balance. Specifically, coefficients which are multiplied by the video signal for left-eye and the video signal for right-eye are calculated so as to have a state where white balance is adjusted.

The factor-specific correction amount calculation unit 143 for each of brightness, size, rotation, and parallel movement calculates the correction amount of the other image with reference to one image selected from the ILE and the IRE by the reference adjustment unit 142. Hereinafter, as illustrated as the operation of the correction amount calculation unit 140, a calculation method for a correction amount and a correction method when the relative amount of displacement of brightness, size, inclination angle, and position of the IRE is detected with reference to the ILE will be described.

First, a calculation method for a correction amount and a correction method relating to brightness will be described. Since the ratio of brightness of the IRE with reference to the ILE is detected by the correction amount calculation unit 140, if the reference adjustment unit 142 selects the ILE as a reference, the reciprocal of the ratio of brightness becomes a correction amount. The factor-specific correction amount calculation unit 143 multiplies the respective pixel values of the video signal for right-eye by the correction amount to match the IRE with the ILE. If the reference adjustment unit 142 selects the IRE as a reference, the ratio of brightness becomes a correction amount, and the factor-specific correction amount calculation unit 143 multiplies the respective pixel values of the video signal for left-eye by the correction amount to match the ILE with the IRE.

Next, a calculation method for a correction amount and a correction method relating to size will be described. Since the ratio of size of the IRE with reference to the ILE is detected by the correction amount calculation unit 140, if the reference adjustment unit 142 selects the ILE as a reference, the reciprocal of the ratio of size becomes a correction amount. The factor-specific correction amount calculation unit 143 performs enlargement processing on the video signal for right-eye on the basis of the correction amount to match the IRE with the ILE. If the reference adjustment unit 142 selects the IRE as a reference, the ratio of size becomes a correction amount, and the factor-specific correction amount calculation unit 143 performs enlargement processing on the video signal for left-eye on the basis of the correction amount to match the ILE with the IRE.

Next, a calculation method for a correction amount and a correction method relating to an inclination angle will be described. Since the difference in the inclination angle of the IRE with reference to the ILE is detected by the correction amount calculation unit 140, if the reference adjustment unit 142 selects the ILE as a reference, a value which is −1 times the difference in the inclination angle becomes a correction amount. The factor-specific correction amount calculation unit 143 performs rotation processing on the video signal for right-eye on the basis of the correction amount to match the IRE with the ILE. If the reference adjustment unit 142 selects the IRE as a reference, the difference in the inclination angle becomes a correction amount, and the factor-specific correction amount calculation unit 143 performs rotation processing on the video signal for left-eye on the basis of the correction amount to match the ILE with the IRE.

Next, a calculation method for a correction amount and a correction method relating to a position will be described. Since the difference in the position of the IRE with reference to the ILE is detected by the correction amount calculation unit 140, if the reference adjustment unit 142 selects the ILE as a reference, a value which is −1 times the difference in the position becomes a correction amount. The factor-specific correction amount calculation unit 143 performs parallel movement processing on the video signal for right-eye on the basis of the correction amount to match the IRE with the ILE. If the reference adjustment unit 142 selects the IRE as a reference, the difference in the position becomes a correction amount, and the factor-specific correction amount calculation unit 143 performs parallel movement processing on the video signal for left-eye on the basis of the correction amount to match the ILE with the IRE.

The correction amount calculation unit 140 outputs the calculated correction amount and the video signal for left-eye and the video signal for right-eye which are subjected to predetermined strain correction so as to remove strain in advance. The correction unit 150 corrects the video signal for left-eye and the video signal for right-eye on the basis of the correction amount calculated by the correction amount calculation unit 140.

The correction unit 150 performs gain multiplication in terms of brightness, performs white balance matrix multiplication in terms of white balance, performs zooming processing in terms of size, performs rotation processing in terms of rotation, and performs parallel movement processing (position conversion) in terms of parallel movement. The video signal for left-eye and the video signal for right-eye which are processed by the correction unit 150 are video signals in which strain in the image is removed by strain correction. For this reason, the correction unit 150 performs processing for restoring intrinsic strain on the video signal for left-eye and the video signal for right-eye after correction is performed. The restoration processing is adjusted so as to perform reverse conversion when strain is removed.

The video signal for left-eye and the video signal for right-eye in which displacement other than strain is corrected are subjected to predetermined image processing (image processing for display, such as pixel number conversion, edge correction, or color adjustment) in the image processing unit 160 and are output to the image display device 203 as a monitor. The image display device 203 displays an image including the IRE and the ILE on the basis of the video signal for left-eye and the video signal for right-eye subjected to the image processing by the image processing unit 160.

In the above-described configuration, the displacement detection unit 130, the correction amount calculation unit 140, the correction unit 150, the control unit 180, and parts included in these units are a portion which detects and corrects displacement over time or according to the operating conditions. If this displacement is negligible, these parts are not required.

In a device in which these parts are omitted, the video signal separation unit 120 and the video signal adjustment unit 121 are not necessarily arranged in front of the image processing unit 160, and may be arranged at the back of the image processing unit 160 insofar as the image processing unit 160 performs predetermined image processing in a state where the video signal for left-eye and the video signal for right-eye are mixed.

Next, a modification example of this embodiment will be described. In the above description, although the arrangement of the CMOS sensor is contrived such that the difference in the time at which optical information is accumulated as electrical information is small at the corresponding positions of the ILE and the IRE, a feature in that random access to the CMOS sensor is possible may be used. In this case, addresses are generated such that the access timings at the corresponding positions of the ILE and the IRE become close to each other, and the CMOS sensor scans the light receiving surface according to the generated addresses.

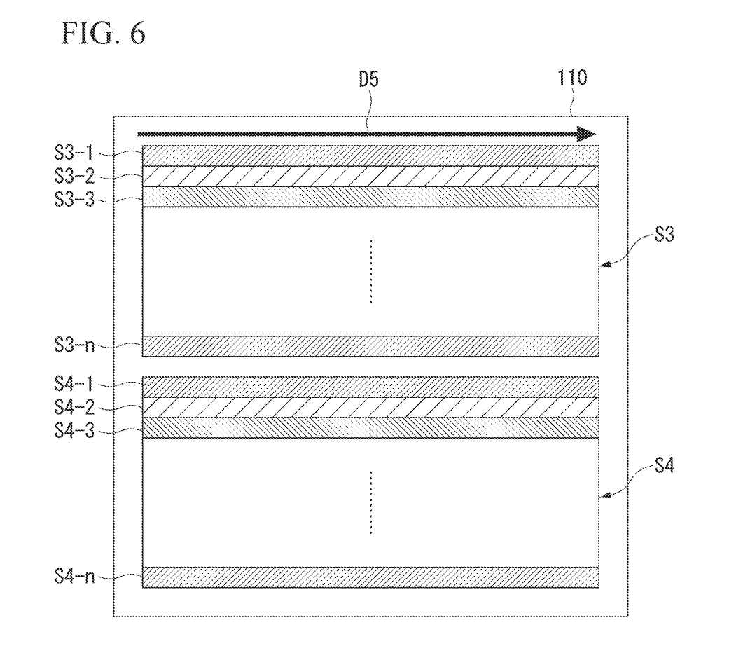

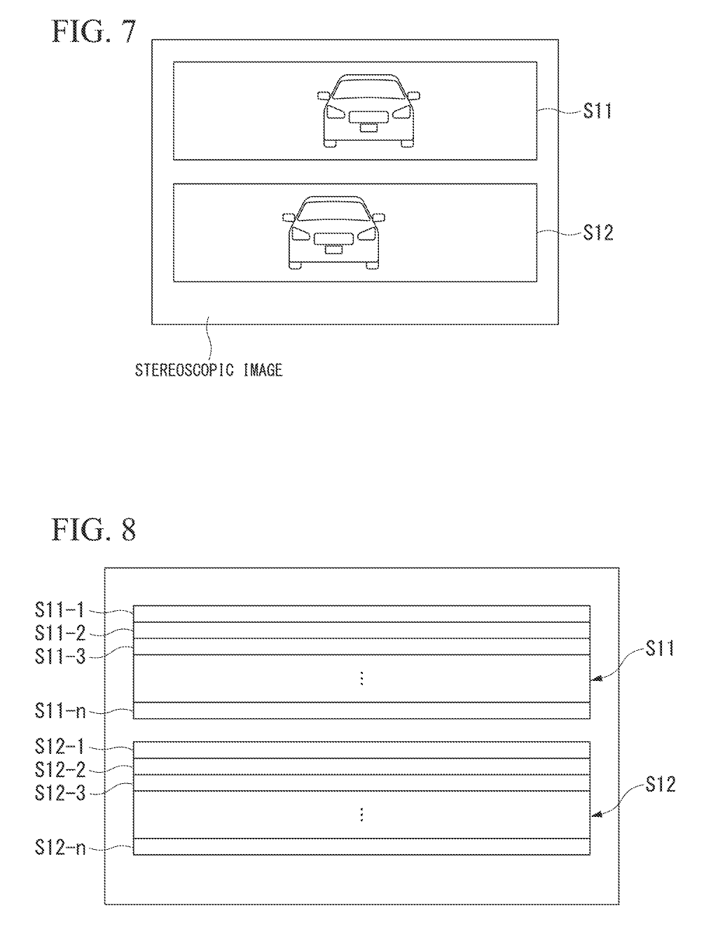

For example, the CMOS sensor 110 may scan the light receiving surface as shown in FIG. 6. FIG. 6 shows a form in which the CMOS sensor 110 scans the light receiving surface by raster scan and reads data constituting a video signal from the respective pixels arranged in a matrix on the light receiving surface. The direction (the direction of arrow D5 of FIG. 6) in which the CMOS sensor 110 scans the light receiving surface is parallel to the parallax direction. A region S3 (first region) and a region S4 (second region) are divided into a plurality of divided regions. The region S3 has a divided region S3-1, a divided region S3-2, a divided region S3-3, . . . , and a divided region S3-n (first divided regions) which are divided in units of rows of pixels arranged in a matrix. The region S4 has a divided region S4-1, a divided region S4-2, a divided region S4-3, . . . , and a divided region S4-n (second divided region) which are divided in units of rows of pixels arranged in a matrix. Each divided region in the region S3 is associated with each divided region of a corresponding row in the region S4. For example, the divided region S3-1 corresponds to the divided region S4-1, and the divided region S3-n corresponds to the divided region S4-n.

The CMOS sensor 110 scans the light receiving surface in the direction of arrow D5 and reads data constituting a video signal from the respective pixels of each divided region. Accordingly, the respective divided regions in the region S3 and the respective divided regions in the region S4 are alternately scanned. Specifically, the respective divided regions are scanned in an order (sequence) of the divided region S3-1, the divided region S4-1, the divided region S3-2, the divided region S4-2, the divided region S3-3, the divided region S4-3, . . . , the divided region S3-n, and the divided region S4-n. In this way, the region S3 and the region S4 are alternately scanned in the same direction with the divided regions divided in units of rows as a scan unit.

Accordingly, the difference in the time (accumulation start time or end time) at which optical information is accumulated as electrical information at the corresponding positions of an ILE and an IRE (the positions in an ILE and an IRE which are identical on the respective images) becomes equal to the scan time per line. For example, the difference between the time at which optical information is accumulated as electrical information in the leftmost pixel of the divided region S3-1 and the time at which optical information is accumulated as electrical information in the leftmost pixel of the corresponding divided region S4-1 is the same as the scan time per line (the scan time of each of the divided region S1-1 and divided region S2-1).

As described above, according to this embodiment, when reading data constituting a video signal from the first region where the ILE is formed and the second region where the IRE is formed, the CMOS sensor 110 reads data by alternately scanning a position where the each first divided region corresponding to the ILE and the each second divided region corresponding to the IRE are correspond, whereby it is possible to make the difference in the time (accumulation start time or end time), at which optical information is accumulated as electrical information, small at the corresponding positions of the ILE and the IRE. For this reason, it is possible to suppress displacement between the left and right images by the characteristic of the rolling shutter. Therefore, an appropriate video signal which is displayed as a high-definition image is obtained, and even if a moving subject is imaged, it is possible to suppress the influence of a time difference between the left and right images.

When the CMOS sensor 110 reads data by scanning a plurality of divided regions by raster scan, since the direction of raster scan is orthogonal to the parallax direction, the difference in the time (accumulation start time or end time), at which optical information is accumulated as electrical information, at the corresponding positions of the ILE and the IRE, is half the scan time per line. For this reason, even if a moving subject is imaged, it is possible to suppress the influence of a time difference between the left and right images.

The video signal separation unit 120 separates the video signal output from the CMOS sensor 110 into a video signal for left-eye and a video signal for right-eye, and the video signal adjustment unit 121 rearranges the order of data constituting each of the video signal for left-eye and the video signal for right-eye so as to be the same as the order of data when the divided regions are scanned in the same direction as the parallax direction by raster scan. Accordingly, even if the arrangement of data in the video signal output from the CMOS sensor 110 is in a special state, it is possible to generate a video signal for left-eye and a video signal for right-eye corresponding to an input format of a normal image display device.

The displacement detection unit 130 detects the amounts of displacement of the ILE and the IRE during the calibration operation, the correction amount calculation unit 140 calculates the correction amounts of the ILE and the IRE during the calibration operation, and the correction unit 150 corrects the video signal according to the correction amounts of the ILE and the IRE, whereby it is possible to correct displacement that is caused by changing over time or the operating conditions. Therefore, it is possible to constantly generate an ILE and an IRE with appropriate parallax, thereby realizing a stereoscopic view.

The displacement detection unit 130 has the factor-specific displacement detection units 131 which detect the amount of displacement for each factor of brightness, white balance, size, rotation, and parallel movement, and the correction amount calculation unit 140 has the factor-specific correction amount calculation units 143 which calculates the correction amount corresponding to the amount of displacement for each type of displacement. Therefore, even if various kinds of displacement occur in a combined manner, it is possible to detect the amount of displacement separately for each type of displacement and to correct each type of displacement.

Although the embodiment of the present invention has been described in detail referring to the drawings, a specific configuration is not limited to the foregoing embodiment, and design changes and the like may be made within a scope without departing from the gist of the present invention.

1. A 3D endoscope device which acquires an image for left-eye and an image for right-eye with parallax, the 3D endoscope device comprising:
an endoscopic scope which has two optical systems that form light corresponding to the image for left-eye and the image for right-eye, and a MOS sensor on which a first light and a second light obtained through the two optical systems are formed separately on a single light receiving surface and which generates a video signal based on formed a first image and a second image;
an image processor which performs image processing on the video signal; and
an image display device which displays an image including the image for left-eye and the image for right-eye based on the video signal processed by the image processor,
wherein a line which connects a center of the first image and a center of the second image formed on the light receiving surface of the MOS sensor is orthogonal to a parallax direction,
on the light receiving surface of the MOS sensor, a first region where the first image is formed is divided into a plurality of first divided regions, and a second region where the second image is formed is divided into a plurality of second divided regions, and
when reading data constituting the video signal from the first region and the second region, the MOS sensor reads the data by alternately scanning a position where the each first divided region corresponding to the image for left-eye and the each second divided region corresponding to the image for right-eye are correspond.

2. The 3D endoscope device according to claim 1,
wherein the MOS sensor reads data by scanning the plurality of first divided regions and the plurality of second divided regions by raster scan, and
a direction of the raster scan is orthogonal to the parallax direction.

3. The 3D endoscope device according to claim 2,
wherein the image processor includes
an image processing unit which performs the image processing,
a separation unit which separates the video signal into a video signal for left-eye corresponding to the image for left-eye and a video signal for right-eye corresponding to the image for right-eye, and
an adjustment unit which rearranges an order of data constituting each of the video signal for left-eye and the video signal for right-eye so as to be the same as an order of data when data is read by scanning the plurality of first divided regions and the plurality of second divided regions by the raster scan in a same direction as the parallax direction.

4. The 3D endoscope device according to claim 3,
wherein the image processor includes
a control unit which instructs a calibration operation before a normal operation or during the normal operation,
a displacement detection unit which detects an amount of displacement of the image for left-eye and the image for right-eye during the calibration operation,
a correction amount calculation unit which calculates correction amounts of the image for left-eye and the image for right-eye during the calibration operation, and
a correction unit which performs correction on the video signal according to the correction amounts of the image for left-eye and the image for right-eye.

5. The 3D endoscope device according to claim 4,
wherein the displacement detection unit detects the amount of displacement for at least one factor of brightness, white balance, size, rotation, and parallel movement, and
the correction amount calculation unit calculates a correction amount corresponding to the amount of displacement for each factor.
